(19) United States
(12) Patent Application Publication
(10) Pub. No.: US 2024/0395030 A1
(43) Pub. Date: Nov. 28, 2024

(54) ELECTRONIC DEVICE FOR IDENTIFYING DISTANCE BETWEEN ELECTRONIC DEVICE AND EXTERNAL OBJECT USING NEURAL NETWORK AND METHOD THEREOF

(71) Applicant: THINKWARE CORPORATION, Seongnam-si (KR)

(72) Inventors: Yosep PARK, Seongnam-si (KR); Yechan CHOI, Seongnam-si (KR)

(73) Assignee: THINKWARE CORPORATION, Seongnam-si (KR)

(21) Appl. No.: 18/670,933

(22) Filed: May 22, 2024

(30) Foreign Application Priority Data
May 23, 2023 (KR) 10-2023-0066610

(51) Int. Cl. G06V 10/82; G06V 10/24; G06V 10/26; G06V 10/764; G06V 20/64

(52) U.S. Cl. CPC G06V 10/82; G06V 10/242; G06V 10/267; G06V 10/764; G06V 20/64; G06V 2201/08

(57) ABSTRACT

A processor of an electronic device according to an embodiment may be configured to: obtain an angle rotated about an optical axis of the camera, through the sensor; identify, in an image obtained through the camera, first coordinates with respect to first vertices of an area in which a visual object corresponding to an external object is included; obtain second coordinates by rotating the first coordinates about a center point of the area, according to the angle; based on a category of the external object, which is identified by a neural network to which the image is inputted, identify third coordinates having a size corresponding to the category, from the second coordinates; and identify a distance between the electronic device and the external object, based on the third coordinates.

### CROSS-REFERENCE TO RELATED APPLICATION(S)

This application is based on and claims priority under 35 U.S.C. § 119 to Korean Patent Application No. 10-2023-0066610, filed on May 23, 2023, in the Korean Intellectual Property Office, the disclosure of which is incorporated by reference herein in its entirety.

### BACKGROUND

### Technical Field

The present disclosure relates to an electronic device for identifying a distance between an electronic device and an external object using a neural network and a method thereof.

### Description of Related Art

Along with the development of image object recognition technologies, various types of services have been emerged. These services may be used for implementing automatic driving, augmented reality, virtual reality, metaverse, or the like and may be provided through electronic devices owned by different users, such as smartphones. The services may be related to hardware and/or software mechanism that mimic human behavior and/or thinking, such as artificial intelligence (AI). The technology related to artificial intelligence may involve techniques utilizing a neural network that simulates a neural network in living organisms.

### SUMMARY

A solution for identifying an object within a rotated image to identify a distance between an electronic device and an external object using a neural network may be required.

According to an embodiment, an electronic device may include a camera, a sensor, and a processor. The processor may be configured to obtain an angle rotated about an optical axis of the camera, through the sensor. The processor may be configured to identify, in an image obtained through the camera, first coordinates with respect to first vertices of an area in which a visual object corresponding to an external object is included. The processor may be configured to obtain second coordinates by rotating the first coordinates about a middle point of the area, according to the angle. The processor may be configured to, based on a category of the external object, identify third coordinates having a size correspond to the category, from the second coordinates which is identified by a neural network to which the image is inputted. The processor may be configured to identify a distance between the electronic device and the external object based on the third coordinates.

According to an embodiment, an electronic device may include a memory and a processor. The processor may be configured to identify first information indicating a combination of a first image and a first area of a visual object within the first image, within the memory. The processor may be configured to obtain, by rotating first coordinates of first vertices of the first area within the first image according to a preset angle, second coordinates. The processor may be configured to rotate the first image about a middle point of the first image within the first image according to the preset angle. The processor may be configured to obtain a second image by segmenting the rotated first image according to the preset angle. The processor may be configured to obtain, by changing the second coordinates based on a class of the visual object indicated by the first information, third coordinates corresponding to the visual object within the second image. The processor may be configured to store, in the memory, second information indicating a combination of a second area indicated by the third coordinates and the second image.

A method of an electronic device may include identifying an angle rotated about an optical axis of a camera, through the sensor. The method may include identifying, in an image obtained through the camera, first coordinates with respect to first vertices of an area in which a visual object corresponding to an external object is included. The method may include obtaining second coordinates by rotating the first coordinates about a middle point of the area, according to the angle. The method may include identifying, based on a category of the external object, third coordinates having a size corresponding to the category, from the second coordinates which is identified by a neural network to which the image is inputted. The method may include identifying a distance between the electronic device and the external object based on the third coordinates.

The electronic device according to embodiments of the disclosure may identify an object in a rotated image, using a neural network, to identify a distance between the electronic device and an external object.

### BRIEF DESCRIPTION OF THE DRAWINGS

The above and other aspects, features, and advantages of certain embodiments of the disclosure will be more apparent from the following description, taken in conjunction with the accompanying, in which:

FIG. 1 illustrates an example of a block diagram of an electronic device according to an embodiment;

FIG. 2A illustrates an example of an electronic device for obtaining a data set for training a neural network, according to an embodiment;

FIG. 2B illustrates an example of an electronic device for obtaining a data set for training a neural network, according to an embodiment;

FIG. 2C illustrates an example of an electronic device for obtaining a data set for training a neural network, according to an embodiment;

FIG. 3 illustrates an example of an electronic device for identifying an external object, according to an embodiment;

FIG. 4A illustrates an example of an electronic device for identifying a distance between an electronic device and an external object according to an embodiment;

FIG. 4B illustrates an example of an electronic device for identifying a distance between an electronic device and an external object according to an embodiment;

FIG. 4C illustrates an example of an electronic device for identifying a distance between an electronic device and an external object according to an embodiment;.

FIG. 5 illustrates an example of a flowchart of an operation of an electronic device according to an embodiment;

FIG. 6 illustrates an example of a flowchart of an operation of an electronic device according to an embodiment;

FIG. 7 is an example flowchart diagram for describing an operation of an electronic device for training a neural network based on a set of training data; and

FIG. 8 is a block diagram of an electronic device according to an embodiment.

### DETAILED DESCRIPTION

An electronic device according to various embodiments disclosed herein may be one of various types of electronic devices. The electronic devices may include, for example, a portable communication device (e.g., a smartphone), a computer device, a portable multimedia device, a portable medical device, a camera, an electronic device, or a home appliance. The electronic device according to an embodiment of the present disclosure is not limited to those described above.

It should be appreciated that various embodiments of the present disclosure and the terms used therein are not intended to limit the technological features set forth herein to particular embodiments and include various changes, equivalents, or replacements for a corresponding embodiment. In conjunction with the description of the drawings, similar reference numerals may be used to refer to similar or related elements. It is to be understood that a singular form of a noun corresponding to an item may include one or more of the items, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with (to)” or “connected with (to)” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may be interchangeably used with other terms, for example, “logic”, “logic block”, “part”, or “circuit”. A module may be a single integral component, or a minimum unit or part thereof, adapted to perform one or more functions. For example, according to an example, the module may be implemented in a form of an application-specific integrated circuit (ASIC).

Various embodiments of the present disclosure as set forth herein may be implemented as software (e.g., a program) including one or more instructions that are stored in a storage medium (e.g., an internal memory or an external memory) that is readable by a machine (e.g., an electronic device 101). For example, a processor (e.g., a processor 120) of the machine (e.g., an electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

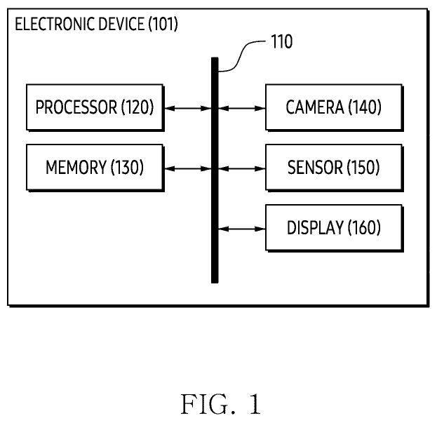

FIG. 1 illustrates an example of a block diagram of an electronic device according to an embodiment.

Referring to FIG. 1, according to an embodiment, an electronic device 101 may include at least one of a processor 120, a memory 130, a camera 140, a sensor 150, or a display 160. The processor 120, the memory 130, the camera 140, the sensor 150, and the display 160 may be electronically and/or operably coupled with each other by an electronic component such as a communication bus 110. Hereinafter, when a hardware component is referred to as being operatively coupled with another one, it may mean that a direct connection or an indirect connection between the hardware components is established by wire or wirelessly such that a second hardware is controlled by a first hardware component among the hardware components. Although an embodiment is illustrated in different blocks, embodiments are not limited thereto. Some of the hardware components of FIG. 1 may be incorporated into a single integrated circuit such as a system on chip (SoC). The type and/or number of hardware components included in the electronic device 101 are not limited to those shown in FIG. 1. For example, the electronic device 101 may include only some of the hardware components shown in FIG. 1.

According to an embodiment, the electronic device 101 may include hardware for processing data based on one or more instructions. The hardware for processing data may include the processor 120. For example, the hardware for processing data may include an arithmetic and logic unit (ALU), a floating point unit (FPU), a field programmable gate array (FPGA), a central processing unit (CPU), and/or an application processor (AP). The processor 120 may have a structure of a single-core processor or a structure of a multi-core processor such as a dual-core, a quad-core, a hexa-core, or an octa-core.

According to an embodiment, the memory 130 of the electronic device 101 may include a hardware component for storing data and/or instructions input and/or output to/from the processor 120 of the electronic device 101. For example, the memory 130 may include a volatile memory such as a random-access memory (RAM) and/or a non-volatile memory such as a read-only memory (ROM). For example, the volatile memory may include at least one of dynamic RAM (DRAM), static RAM (SRAM), cache RAM, and pseudo SRAM (PSRAM). For example, the non-volatile memory may include at least one of a programmable ROM (PROM), an erasable PROM (EPROM), an electrically erasable PROM (EEPROM), a flash memory, a hard disk, a compact disk, a solid state drive (SSD), and an embedded multi-media card (eMMC).

According to an embodiment, the camera 140 of the electronic device 101 may include a lens assembly or an image sensor. The lens assembly may collect light emitted from a subject for which an image is to be captured. The lens assembly may include one or more lenses. According to an embodiment, the camera 140 may include a plurality of lens assemblies. For example, some of the plurality of lens assemblies of the camera 140 may have the same lens attributes (e.g., view angle, focal length, auto focus, f-number, or optical zoom), or at least one lens assembly may have one or more lens attributes different from those of other lens assembly.

The lens assembly may include a wide-angle lens or a telephoto lens. According to an embodiment, a flash may include one or more light emitting diodes (LEDs) (e.g., a red-green-blue (RGB) LED, a white LED, an infrared LED, or an ultraviolet LED) or a xenon lamp. For example, the image sensor may obtain an image corresponding to the subject by converting light emitted or reflected from the subject and transmitted through the lens assembly into an electrical signal. According to an embodiment, the image sensor may include, for example, one image sensor selected from image sensors having different attributes, such as an RGB sensor, a black and white (BW) sensor, an IR sensor, or a UV sensor, a plurality of image sensors having the same attributes, or a plurality of image sensors having different attributes. Each image sensor included in the image sensor may be implemented, for example, using a charged coupled device (CCD) sensor or a complementary metal oxide semiconductor (CMOS) sensor.

According to an embodiment, the sensor 150 of the electronic device 101 may include an inertial measurement sensor such as an inertial measurement unit (IMU) sensor. For example, the sensor 150 may include an acceleration sensor and/or a gyro sensor. For example, the acceleration sensor may output electrical information indicating a magnitude of gravitational acceleration measured on each of a plurality of specified axes (e.g., x-axis, y-axis, z-axis) perpendicular to each other. For example, the processor 120 of the electronic device 101 may detect a motion of the electronic device 101 in a physical space, based on electrical information output from the acceleration sensor. For example, the motion detected by the electronic device 101 may indicate an orientation of the electronic device 101 detected by the acceleration sensor. For example, the motion detected by the electronic device 101 may include a roll motion, a yaw motion, and/or a pitch motion. For example, the roll motion may include a motion of the electronic device 101 that rotates about an optical axis of the camera 140 of the electronic device 101. For example, the electronic device 101 may identify an angle rotated about the optical axis of the camera 140, through the sensor 150. The electronic device 101 may identify a roll motion with respect to the optical axis. The electronic device 101 may obtain the angle corresponding to the roll motion.

The display 160 of the electronic device 101 according to an embodiment may output visualized information to its user. For example, the display 160 may be controlled by the processor 120 including circuitry such as a graphic processing unit (GPU) to output visualized information to the user. The display 160 may include a flat panel display (FPD) and/or an electronic paper. The FPD may include a liquid crystal display (LCD), a plasma display panel (PDP), and/or one or more light emitting diodes (LEDs). The LED may include an organic LED (OLED). For example, the electronic device 101 may display a visual object corresponding to an external object on the display 160. For example, the electronic device may highlight and display the visual object, based on identifying the visual object corresponding to the external object using a neural network. For example, highlighting and displaying the visual object may include displaying an area including the visual object in a specified color (e.g., red, yellow, or blue). However, the disclosure is not limited thereto.

According to an embodiment, the electronic device 101 may identify an image in the memory 130. The electronic device 101 may identify a first image corresponding to the image in the memory 130. The electronic device 101 may identify a visual object in the first image. For example, the electronic device 101 may identify a class (or category) of the visual object. The electronic device 101 may identify a first area corresponding to the visual object. For example, the first area corresponding to the visual object may be referred to as a bounding box. The electronic device 101 may identify first information indicating a combination of the first image and a first area of a visual object in the first image.

According to an embodiment, the electronic device 101 may rotate the first image at a specified angle. According to an embodiment, the electronic device 101 may rotate a first area corresponding to a portion of the first image at a specified angle. For example, the electronic device 101 may rotate first coordinates of first vertices of the first area about a center point of the first area in the first image. The center point of the first area may be identified by the processor 120, based on a center of gravity of effective pixels included in the area and/or an intersection point of line segments connecting each of the first coordinates. The electronic device 101 may identify second coordinates based on rotation of the first coordinates.

According to an embodiment, the electronic device 101 may rotate the first image about a center point of the first image within the first image according to a specified angle. For example, the center point of the first image may be identified by the processor 120, based on a center of gravity of effective pixels included in the image and/or an intersection point of line segments connecting vertices of the first image.

According to an embodiment, the electronic device 101 may obtain a second image based on segmenting the first image rotated according to the specified angle. For example, the electronic device 101 may segment the first image into different sizes, according to the specified angle. For example, the larger the specified angle, the electronic device 101 may acquire the second image having the smaller size.

According to an embodiment, the electronic device 101 may identify the class of the visual object represented by the first information indicating a combination of the first image and the first area. The electronic device 101 may change the second coordinates based on the class of the visual object. For example, the class may be related to a type of visual objects such as a person, a bike, a sedan, a sports utility vehicle (SUV), and/or a bus. For example, the electronic device 101 may obtain third coordinates corresponding to the visual object and obtained by changing the second coordinates, based on the class of the visual object. According to an embodiment, the electronic device 101 may identify a second area, based on the third coordinates. For example, the second area obtained based on the third coordinates may include an area for identifying the visual object rotated. According to an embodiment, the electronic device 101 may store, in the memory 130, second information indicating a combination of the second image and the second area indicated by the third coordinates.

According to an embodiment, the electronic device 101 may obtain truth data based on the second information. The electronic device 101 may train a neural network using the truth data. According to an embodiment, the electronic device 101 may input an image to the neural network trained using the truth data based on the second information. The electronic device 101 may identify a visual object corresponding to an external object within the image, based on inputting the image to the neural network. For example, the electronic device 101 may identify an inclined visual object in the image, using the neural network.

According to an embodiment, the electronic device 101 may obtain an angle rotated about the optical axis of the camera 140, based on the sensor 150. For example, the electronic device 101 may identify a roll motion of the camera with respect to the optical axis. The electronic device 101 may identify the angle corresponding to the roll motion, based on identifying the roll motion with respect to the optical axis.

According to an embodiment, the electronic device 101 may obtain an image through the camera 140. For example, the electronic device 101 may identify a visual object corresponding to an external object in the image obtained through the camera 140. For example, the electronic device 101 may identify an area including the visual object corresponding to the external object in the image. The electronic device 101 may identify first vertices of the area including the visual object. For example, the area may include a bounding box including the visual object. For example, the electronic device 101 may identify first coordinates for the first vertices. For example, the first vertices may correspond to vertices of the bounding box. For example, the first coordinates may include coordinates in a two-dimensional virtual coordinate system with a vertex of the area as an origin. For example, the two-dimensional virtual coordinate system may be formed of an x-axis corresponding to a lowermost periphery of the image and a y-axis corresponding to a leftmost periphery of the image. For example, the two-dimensional virtual coordinate system may be formed of an x-axis corresponding to an uppermost periphery of the image and a y-axis corresponding to a rightmost periphery of the image. However, the disclosure is not limited thereto.

According to an embodiment, the electronic device 101 may rotate the first coordinates about a center point of the area corresponding to the visual object, according to the angle at which the electronic device 101 rotates about the optical axis of the camera 140. For example, the center point of the area may be identified by the processor 120, based on a center of gravity of effective pixels included in the area and/or an intersection point of line segments connecting each of the first coordinates. The electronic device 101 may obtain the second coordinates based on the rotation of the first coordinates.

According to an embodiment, the electronic device 101 may identify the category of the external object identified by the neural network to which the image is input. The electronic device 101 may obtain third coordinates having a size corresponding to the category from the second coordinates, based on the category of the external object. For example, the electronic device 101 may obtain the third coordinates based on a position of the visual object in the image. For example, the image may include distortion by the camera 140. For example, the distortion may include radial distortion and/or tangential distortion. The electronic device 101 may obtain the third coordinates based on the position of the visual object to compensate for the distortion. The electronic device 101 may form an area based on the third coordinates.

According to an embodiment, the electronic device 101 may identify the distance between the electronic device 101 and the external object, based on the area formed by the third coordinates. For example, the electronic device 101 may identify the distance, based on a trigonometric function and a width of an area formed by the third coordinates.

According to an embodiment, the electronic device 101 may identify a bounding box corresponding to a rear surface of the external object, based on the third coordinates and the category of the external object (or the category of the visual object). For example, the category of the external object and/or the visual object may be referred to as a class of the external object and/or the visual object. For example, the electronic device 101 may identify a middle potion of a lower periphery of the bounding box. The electronic device 101 may form a three-dimensional (3D) virtual coordinate system, based on the middle point of the lower periphery of the bounding box. The electronic device 101 may form a virtual object mapped to the visual object in the 3D virtual coordinate system. The electronic device 101 may identify a distance between the electronic device 101 and the external object, based on the virtual object identified in the 3D virtual coordinate system.

According to an embodiment, the electronic device 101 may identify a bounding box corresponding to the rear surface of the external object. For example, the bounding box corresponding to the rear surface of the external object may be identified based on a distance between a center line of an image and an area including a visual object. For example, the electronic device 101 may identify the bounding box corresponding to the rear surface of the external object, based on identifying the distance. The electronic device 101 may identify the distance between the electronic device 101 and the external object, based on the bounding box.

According to an embodiment, the electronic device 101 may identify a third distance between the electronic device 101 and the external object, using a first distance identified based on the 3D virtual coordinate system and a second distance obtained using the width of the area formed by the third coordinates and the trigonometric function. For example, the electronic device 101 may apply a weight to the first distance and the second distance. The electronic device 101 may identify the third distance between the electronic device 101 and the external object, based on applying different weights to the first distance and the second distance. The electronic device 101 may identify the third distance based on applying a weighted mean to the first distance and the second distance.

As described above, the electronic device 101 according to an embodiment may identify a visual object corresponding to the external object in the image. The electronic device 101 may obtain coordinates of an area including the visual object in the image. The electronic device 101 may identify the distance between the electronic device 101 and the external object, based on the coordinates. The electronic device 101 may identify the distance while reducing a usage of the processor 120, by identifying the distance based on the coordinates. The electronic device 101 may identify an inclined visual object in the image, by identifying the distance based on the coordinates.

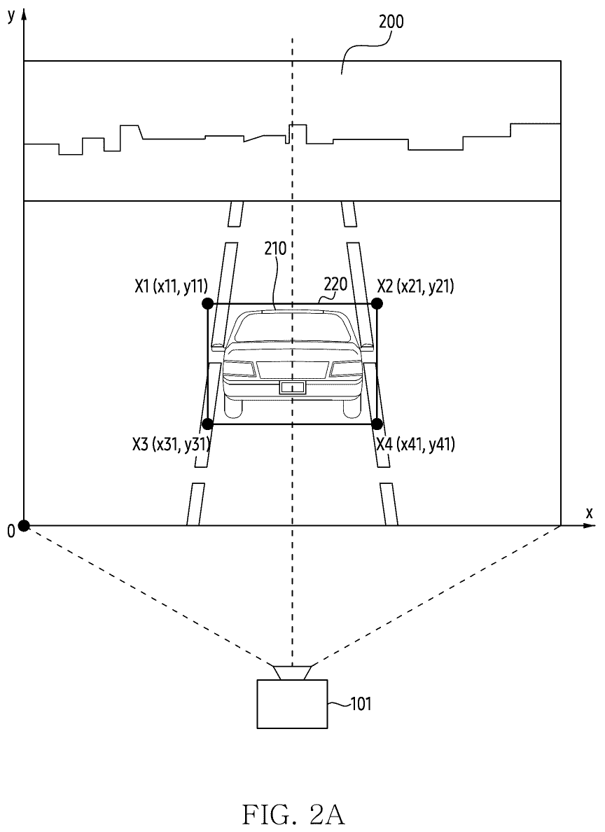

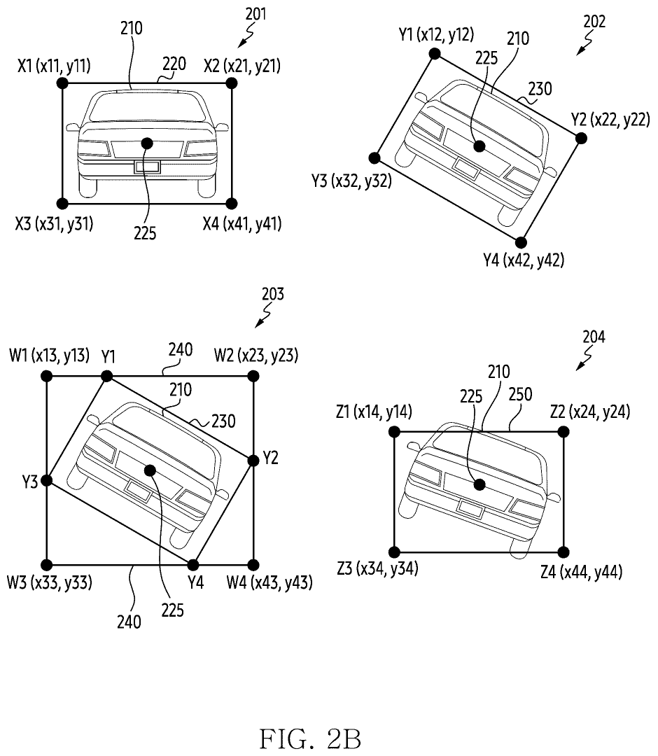

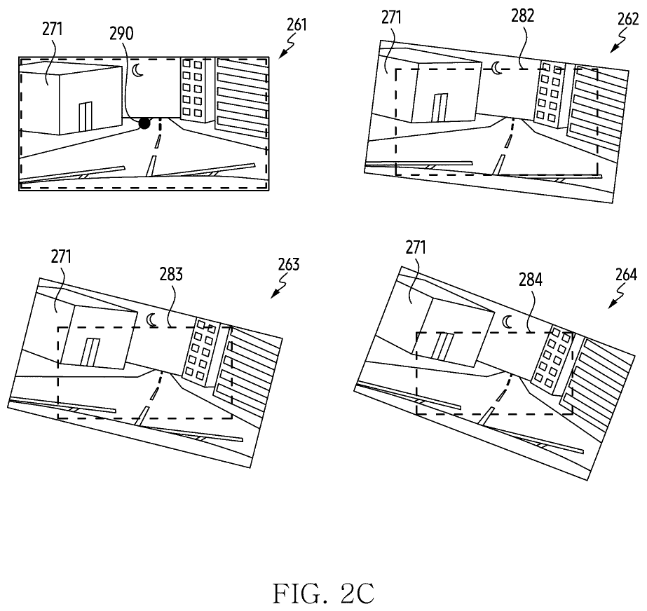

FIG. 2A illustrates an example of an electronic device for obtaining a data set for training a neural network, according to an embodiment. FIG. 2B illustrates an example of an electronic device for obtaining a data set for training a neural network, according to an embodiment of the disclosure. FIG. 2C illustrates an example of an electronic device for obtaining a data set for training a neural network, according to an embodiment. The electronic device 101 of FIGS. 2A to 2C may include the electronic device 101 of FIG. 1. Operations of FIGS. 2A to 2C may be performed by the processor 120 of FIG. 1.

Referring to FIG. 2A, the electronic device 101 according to an embodiment may identify a first image 200 in a memory (e.g., the memory 130 of FIG. 1). The electronic device 101 may identify a visual object 210 corresponding to an external object in the first image 200. The electronic device 101 may identify a class (or category) of the visual object 210. The electronic device 101 may identify a first area 220 corresponding to the visual object 210, based on identifying the visual object 210. For example, the first area 220 may include first vertices (X1, X2, X3, X4). For example, the electronic device 101 may identify coordinates of each of the first vertices (X1, X2, X3, X4) of the first area 220. For example, the coordinates of the first point X1 may be (x11, y11). For example, the coordinates of the second point X2 may be (x21, y21). For example, the coordinates of the third point X3 may be (x31, y31). For example, the coordinates of the fourth point X4 may be (x41, y41). According to an embodiment, the electronic device 101 may identify first information indicating a combination of the first image 200 and the first area 220 of the visual object 210.

For example, in a two-dimensional virtual coordinate system in which a lower left vertex of the image 200 is set as an origin, the electronic device 101 may identify first coordinates of each of the first vertices (X1, X2, X3, X4). For example, the x-axis of the two-dimensional virtual coordinate system may be formed along a lowermost edge of the first image 200. The y-axis of the two-dimensional virtual coordinate system may be formed along a leftmost edge of the first image 200.

Referring to FIG. 2B, according to an embodiment, in a first example 201, the electronic device 101 may rotate the first coordinates of the first vertices (X1, X2, X3, X4) of the first area 220 about a center point 225 of the first area 220 in the first image 200, at a specified angle. In a second example 202, the electronic device 101 may obtain the second coordinates by rotating the first coordinates of the first vertices (X1, X2, X3, X4) of the rotated first area 230. For example, the electronic device 101 may identify the second vertices (Y1, Y2, Y3, Y4) for obtaining the second coordinates. For example, the coordinates of the fifth point Y1 about which the first point X1 is rotated may be (x12, y12). For example, the coordinates of the sixth point Y2 about which the second point X2 is rotated may be (x22, y22). For example, the coordinates of the seventh point Y3 about which the third point X3 is rotated may be (x32, y32). For example, the coordinates of the eighth point Y4 about which the fourth point X4 is rotated may be (x42, y42).

Referring to a third example 203, the electronic device 101 according to an embodiment may identify a second area 240 based on the rotated first area 230 and the rotated image. For example, the second area 240 may include third vertices (W1, W2, W3, W4). The coordinates of the third vertices (W1, W2, W3, W4) may be related to a minimum value and a maximum value in an x-axis range of the second area 240, and a minimum value and a maximum value in a y-axis range of the second area 240. For example, the electronic device 101 may identify the coordinates of each of the third vertices (W1, W2, W3, W4). For example, the coordinates of the ninth point W1 may be (x13, y13) (e.g., the minimum value in the x-axis range and the maximum value in the y-axis range). For example, the coordinates of the tenth point W2 may be (x23, y23) (e.g., the maximum value in the x-axis range and the maximum value in the y-axis range). For example, the coordinates of the eleventh point W3 may be (x33, y33) (e.g., the minimum value in the x-axis range and the minimum value in the y-axis range). For example, the coordinates of the twelfth point W4 may be (x43, y43) (e.g., the maximum value in the x-axis range and the minimum value in the y-axis range).

Referring to a fourth example 204, the electronic device 101 according to an embodiment may identify a third area 250 corresponding to the rotated visual object 210, based on the third vertices (W1, W2, W3, W4) and the vertices (Y1, Y2, Y3, Y4) of the rotated first area 230. The electronic device 101 may identify the fourth vertices (Z1, Z2, Z3, Z4) of the third area 250. For example, the coordinates of the thirteenth point Z1 may be (x14, y14). For example, the coordinates of the fourteenth point Z2 may be (x24, y24). For example, the coordinates of the fifteenth point Z3 may be (x34, y34). For example, the coordinates of the sixteenth point Z4 may be (x44, y44).

Referring to FIG. 2C, the electronic device 101 may rotate a first image 271 based on a specified angle. The electronic device 101 may segment the rotated first image 271. The electronic device 101 may obtain a second image, based on segmenting of the first image 271.

Referring to a first example 261, the electronic device 101 according to an embodiment may identify a first image 271 in the memory. For example, the electronic device 101 may identify a non-rotated first image 271 in the memory. The electronic device 101 may identify a center point 290 of the first image 271. The electronic device 101 may identify the center point 290. The center point 290 of the first image 271 may include the center of gravity in the image 271. The electronic device 101 may obtain a second image based on obtaining the first image 271 with respect to the center point 290.

Referring to a second example 262, the electronic device 101 according to an embodiment may rotate the first image 271 about the center point 290 by a first angle. For example, the first angle may include about 5 degrees. The electronic device 101 may segment a first portion 282 of the first image 271 based on rotating the first image 271 by the first angle. The electronic device 101 may obtain a second image corresponding to the first portion 282 based on segmenting the first portion 282.

Referring to a third example 263, the electronic device 101 according to an embodiment may rotate the first image 271 about the center point 290 by a second angle. For example, the second angle may include about 10 degrees. For example, the second angle may include an angle greater than the first angle. The electronic device 101 may identify a second portion 283 of the first image 271 based on rotating the first image 271 by the second angle. The electronic device 101 may obtain a second image corresponding to the second portion 283 based on identifying the second portion 283.

Referring to a fourth example 264, the electronic device 101 according to an embodiment may rotate the first image 271 about the center point 290 by a third angle. For example, the third angle may include about 20 degrees. For example, the third angle may include an angle greater than the second angle. For example, the second angle may include an angle which is less than the third angle and greater than the first angle. The electronic device 101 may identify a third portion 284 of the first image 271 based on rotating the first image 271 by the third angle. The electronic device 101 may obtain a second image corresponding to the third portion 284, based on identifying the third portion 284.

According to an embodiment, the electronic device 101 may obtain second information indicating a combination of the second image and the coordinates indicating the visual object identified in the second image obtained by segmenting a portion (e.g., the first portion 282, the second portion 283, the third portion 284) of the first image 271. For example, the coordinates indicating the visual object identified in the second image obtained by segmenting the portion (e.g., the first portion 282, the second portion 283, and the third portion 284) of the first image 271 may be obtained based on operations performed in FIG. 2B. The electronic device 101 may store the second information into a memory, based on obtaining the second information.

According to an embodiment, the electronic device 101 may train a neural network, using truth data based on the second information stored in the memory. The electronic device 101 may input an image to the neural network to identify a visual object corresponding to an external object in the input image.

As described above, according to an embodiment, the electronic device 101 may obtain information for training the neural network. For example, the electronic device 101 may obtain the information for training the neural network, based on rotation of the image stored in the memory. For example, the electronic device 101 may obtain the information for training the neural network, based on the coordinates of an area corresponding to visual objects identified in the rotated image. The electronic device 101 may train the neural network using the rotated image and identify the external object using the neural network based on the information. The electronic device 101 may identify an inclined external object by identifying the external object using the neural network. The electronic device 101 may reduce the usage of a processor (e.g., the processor 120 of FIG. 1) by identifying the external object based on the coordinates.

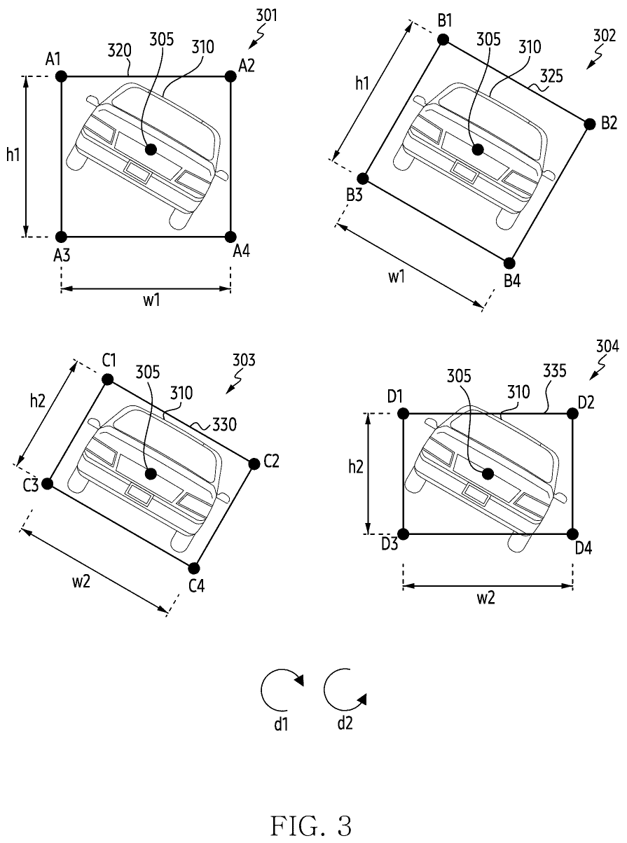

FIG. 3 illustrates an example of an electronic device for identifying an external object according to an embodiment. The electronic device 101 of FIG. 3 may include the electronic device 101 of FIGS. 1, 2A, 2B, and/or 2C. Operations of FIG. 3 may be performed by the processor 120 of FIG. 1. Operations of FIG. 3 may be performed by the processor 120 using a neural network.

Referring to FIG. 3, the electronic device 101 according to an embodiment may obtain an image through a camera (e.g., the camera 140 of FIG. 1). For example, the electronic device 101 may obtain the image in the state of identifying an angle rotated about an optical axis of the camera, through a sensor (e.g., the sensor 150 of FIG. 1). For example, the electronic device 101 may identify a roll motion with respect to the optical axis of the camera. The electronic device 101 may obtain the angle corresponding to the roll motion, based on identifying the roll motion with respect to the optical axis. For example, the electronic device 101 may apply a filter to the image to remove noise of the image obtained in the rotated state. For example, the electronic device 101 may apply a Kalman filter and/or a low-pass filter to the image.

Referring to a first example 301, the electronic device 101 according to an embodiment may identify a visual object 310 corresponding to an external object in the image. The electronic device 101 may identify a first area 320 including the visual object 310 based on the identification of the visual object 310. For example, the electronic device 101 may identify a width w1 of the first area 320. The electronic device 101 may identify a height h1 of the first area 320. The electronic device 101 may identify a size of the first area 320 based on the width w1 and the height h1. For example, the electronic device 101 may identify first vertices (A1, A2, A3, A4) of the area 320. The electronic device 101 may identify first coordinates of the first vertices (A1, A2, A3, A4).

Referring to a second example 302, the electronic device 101 according to an embodiment may identify a center point 305 of the first area 320, based on identifying the first coordinates of the first vertices (A1, A2, A3, A4). For example, the center point 305 of the first area 320 may include a center of gravity of pixels forming the first area 320. The electronic device 101 may rotate the first vertices (A1, A2, A3, A4) about the center point 305 of the first area 320. For example, the electronic device 101 may identify an angle corresponding to a roll motion with respect to the optical axis of the camera. The electronic device 101 may rotate the first vertices (A1, A2, A3, A4) about the center point 305 by an angle corresponding to the angle. For example, the electronic device 101 may obtain the second vertices (B1, B2, B3, B4) by rotating the first vertices (A1, A2, A3, A4) in a first direction dl. For example, the first direction dl may be a clockwise direction.

According to an embodiment, the electronic device 101 may obtain the second vertices (B1, B2, B3, B4) by rotating the first vertices (A1, A2, A3, A4) of the first example. For example, the electronic device 101 may obtain second coordinates of the second vertices (B1, B2, B3, B4). The electronic device 101 may obtain a second area 325 based on the second coordinates of the second vertices (B1, B2, B3, B4). For example, the width w1 and the height hl of the first area 320 of the first example 301 may be substantially the same as the width w1 and the height h2 of the second example 302.

Referring to a third example 303, the electronic device 101 according to an embodiment may change the second coordinates of the second vertices (B1, B2, B3, B4) of the second example 302. For example, the electronic device 101 may identify a category of the visual object 310. The electronic device 101 may change the size of the second area 325 based on the category of the visual object 310. The electronic device 101 may change the width w1 of the second area 325 based on the category of the visual object 310. For example, the electronic device 101 may obtain the width w2 based on the category of the visual object 310. For example, the electronic device 101 may change the height hl of the second area 325 based on the category of the visual object 310. For example, the electronic device 101 may obtain the height h2 based on the category of the visual object 310.

For example, the electronic device 101 may change the second coordinates of the second vertices (B1, B2, B3, B4), based on the category of the visual object 310. For example, the electronic device 101 may identify third vertices (C1, C2, C3, C4) obtained by changing the second vertices (B1, B2, B3, B4), based on the category of the visual object 310. The electronic device 101 may identify a third area 330 based on the third vertices (C1, C2, C3, C4), the width w2, and/or the height h2. For example, the third area 330 may include third coordinates of the third vertices (C1, C2, C3, C4) having a size corresponding to the visual object 310.

Referring to a fourth example 304, the electronic device 101 according to an embodiment may rotate the third vertices (C1, C2, C3, C4). For example, the electronic device 101 may rotate the third vertices (C1, C2, C3, C4) in a second direction d2. For example, the electronic device 101 may rotate the third vertices (C1, C2, C3, C4) about the center point 305 in the second direction d2. The electronic device 101 may obtain fourth vertices (D1, D2, D3, D4) based on the rotation of the third vertices (C1, C2, C3, C4) in the second direction d2. The electronic device 101 may identify fourth coordinates of the fourth vertices (D1, D2, D3, D4). The width w2 of the fourth area 335 formed by the fourth vertices (D1, D2, D3, D4) may be substantially the same as the width w2 of the third area 330. The height h2 of the fourth area 335 formed by the fourth vertices (D1, D2, D3, D4) may be substantially the same as the height h2 of the third area 330.

According to an embodiment, the electronic device 101 may identify the fourth coordinates of the fourth vertices (D1, D2, D3, D4) based on the operations in the first example 301 to the fourth example 304. The electronic device 101 may identify a distance between the electronic device 101 and the external object corresponding to the visual object 310, based on the fourth coordinates of the fourth vertices (D1, D2, D3, D4).

As described above, according to an embodiment, the electronic device 101 may identify the distance between the electronic device 101 and the external object corresponding to the visual object, based on the coordinates of an area including visual objects in the image. The electronic device 101 may reduce the usage of the processor (e.g., the processor 120 of FIG. 1) by identifying the distance based on the coordinates.

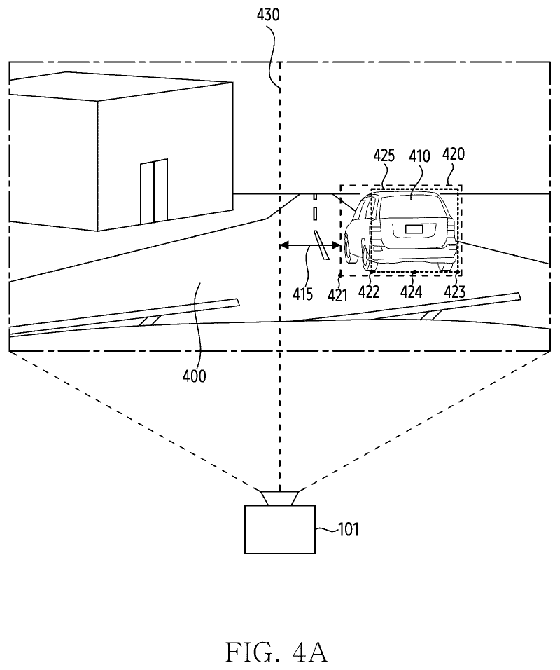

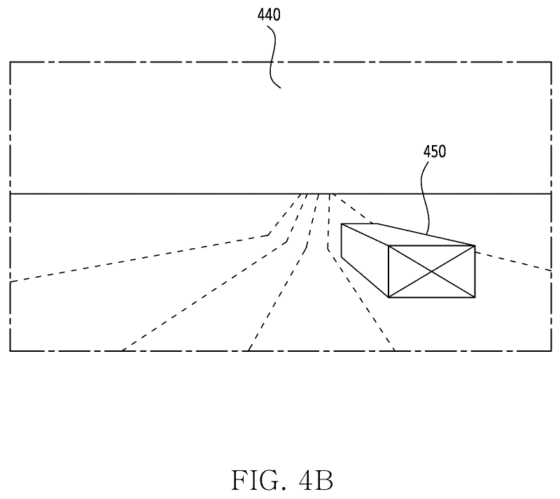

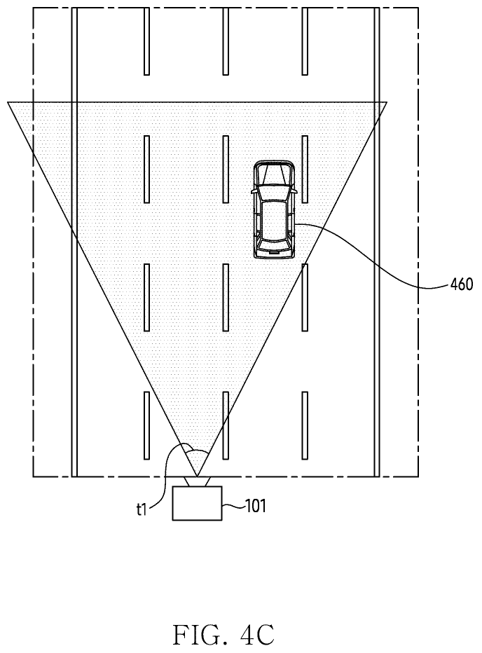

FIG. 4A illustrates an example of an electronic device for identifying a distance between an electronic device and an external object, according to an embodiment. FIG. 4B illustrates another example of an electronic device for identifying a distance between an electronic device and an external object, according to an embodiment. FIG. 4C illustrates still another example of an electronic device for identifying a distance between an electronic device and an external object, according to an embodiment. The electronic device 101 of FIGS. 4A to 4C may include the electronic device 101 of FIGS. 1, 2A, 2B, 2C, and/or 3. Operations of FIGS. 4A to 4C may be performed by the processor 120 of FIG. 1. The operations of FIGS. 4A to 4C may be performed by the processor 120 using a neural network.

Referring to FIG. 4A, the electronic device 101 according to an embodiment may obtain an image 400 through a camera (e.g., the camera 140 of FIG. 1). The electronic device 101 may identify a visual object 410 corresponding to an external object in the image 400. For example, the external object may include a moving object such as a vehicle. The electronic device 101 may identify a first area 420 including the visual object 410 based on the identification of the visual object 410. For example, the first area 420 may be referred to as a bounding box.

According to an embodiment, the electronic device 101 may identify vertices of the first area 420 based on identifying the area 420 including the visual object 410. The electronic device 101 may identify a first vertex 421 at the lower left of the vertices of the first area 420. The electronic device 101 may identify a first length 415 between the first vertex 421 and a center line 430 of the image 400, based on the identification of the first vertex 421. The first length 415 may include the shortest distance from the center line 430 of the image 400 to the first vertex 421. The electronic device 101 may change the coordinates of the first vertex 421 based on identifying the first length 415. For example, the electronic device 101 may change the x-coordinate of the first vertex 421 based on identifying the first length 415.

According to an embodiment, the electronic device 101 may obtain a second vertex 422 by changing the x-coordinate of the first vertex 421, based on the first length 415. The electronic device 101 may identify a second area 425 included in the first area 420, based on obtaining the second vertex 422. The electronic device 101 may identify a middle point 424 of a lowermost edge of the second area 425, based on identifying the second area 425. For example, the electronic device 101 may identify the middle 424 based on the second vertex 422 of the second area 425 and the third vertex 423 of the second area 425. For example, the middle point 424 may be obtained based on the x coordinates of the second vertex 422 and the third vertex 423. For example, the middle point 424 may be identified based on dividing by ‘2’ a value obtained by adding the x-coordinate of the second vertex 422 and the x-coordinate of the third vertex 423.

Referring to FIG. 4B, the electronic device 101 according to an embodiment may form a 3D virtual coordinate system 440. For example, the 3D virtual coordinate system may be referred to as a virtual space. The electronic device 101 may form a virtual object 450 in the 3D virtual coordinate system 440, based on the second area 425, the middle point 424, and/or the first area 420 obtained in FIG. 4A. For example, the electronic device 101 may map the second area 425, the middle point 424, and/or the first area 420 obtained in FIG. 4A into the 3D virtual coordinate system 440. For example, the electronic device 101 may form the virtual object 450 in the 3D virtual coordinate system 440, based on a camera projection matrix. The electronic device 101 may identify a first distance between the electronic device 101 and an external object corresponding to the virtual object 450, based on the virtual object 450 mapped in the 3D virtual coordinate system 440.

Referring to FIG. 4C, the electronic device 101 according to an embodiment may identify a field of view (FOV) t1 of the camera. The electronic device 101 may obtain an image based on the FOV t1 of the camera. The electronic device 101 may identify a visual object in the image. The electronic device 101 may identify a category of the visual object and an area corresponding to the visual object. The electronic device 101 may identify a width of the area and/or a height of the area. The electronic device 101 may identify pixels corresponding to the width and/or pixels corresponding to the height.

According to an embodiment, the electronic device 101 may identify distortion of an image obtained based on the camera. For example, the distortion may include radiation distortion and/or tangential distortion. The electronic device 101 may obtain an image that compensates for the distortion. For example, referring to the image 400 of FIG. 4A as a distortion-compensated image, the electronic device 101 may identify a second distance between the electronic device 101 and the external object, using the width of the first area 420 including the visual object 410 corresponding to the external object identified in the image 400, and a trigonometric function. For example, the electronic device 101 may identify the second distance based on the width of the first area 420, according to the category of the visual object. For example, the electronic device 101 may identify the second distance between the electronic device 101 and the external object 460, based on the FOV t1 of the camera and the width of the first area 420.

According to an embodiment, the electronic device 101 may apply weights to the first distance and the second distance, respectively. For example, the electronic device 101 may apply a first weight to the first distance. The electronic device 101 may obtain a first value based on applying the first weight to the first distance. For example, the electronic device 101 may apply a second weight to the second distance. The electronic device 101 may obtain a second value based on applying the second weight to the second distance. The electronic device 101 may obtain an average of the first value and the second value. The electronic device 101 may identify a third distance between the electronic device 101 and the external object, based on obtaining the average of the first value and the second value.

As described above, the electronic device 101 according to an embodiment may identify an area identified in an image and including a visual object corresponding to an external object. The electronic device 101 may identify vertices of the area. The electronic device 101 may identify coordinates of each of the vertices of the area. The electronic device 101 may map a virtual object corresponding to the visual object into a 3D virtual coordinate system, based on the coordinates. The electronic device 101 may identify the first distance between the electronic device 101 and the external object, based on the virtual object. The electronic device 101 may identify the second distance between the electronic device 101 and the external object, based on the coordinates. The electronic device 101 may identify the third distance based on the first distance and the second distance. The electronic device 101 may reduce the usage of the processor (e.g., the processor 120 of FIG. 1) by identifying the distances based on the coordinates.

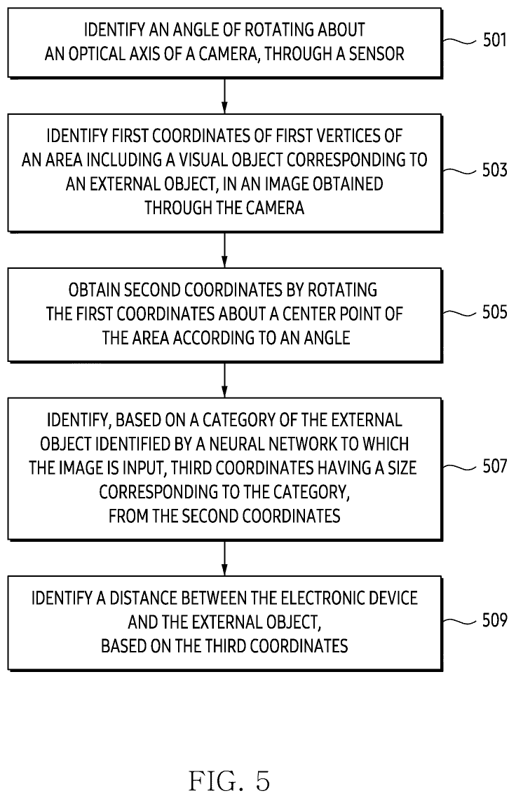

FIG. 5 illustrates an example of a flowchart of an operation of an electronic device according to an embodiment. The electronic device of FIG. 5 may include the electronic device 101 of FIGS. 1, 2A, 2B, 2C, 3, and/or FIGS. 4A to 4C. Operations of FIG. 5 may be performed by the processor 120 of FIG. 1.

Referring to FIG. 5, in operation 501, the electronic device according to an embodiment may identify an angle of rotating about an optical axis of a camera (e.g., the camera 140 of FIG. 1), through a sensor (e.g., the sensor 150 of FIG. 1). For example, the electronic device may identify a roll motion with respect to the optical axis of the camera. The electronic device may identify the angle corresponding to the roll motion, based on identifying the roll motion.

In operation 503, the electronic device according to an embodiment may identify a visual object corresponding to the external object in the image obtained through the camera. The electronic device may identify an area including the visual object corresponding to the external object. The electronic device may identify first vertices of the area. The electronic device may identify first coordinates of the first vertices. The electronic device may identify, in the image, the first coordinates of the first vertices of the area including the visual object corresponding to the external object.

In operation 505, the electronic device according to an embodiment may rotate the first coordinates about the center point of the area, according to the angle at which the electronic device rotates about the optical axis of the camera. For example, the electronic device may rotate the first coordinates about the center point of the area including the visual object, according to the angle corresponding to the roll motion with respect to the optical axis of the camera. The electronic device may obtain the second coordinates based on rotation of the first coordinates. For example, the electronic device may obtain the second coordinates based on rotation of the first coordinates in a first direction.

In operation 507, the electronic device according to an embodiment may input an image to a neural network. The electronic device may identify, based on a category of the external object identified by the neural network to which the image is input, third coordinates having a size corresponding to the category, from the second coordinates.

In operation 509, the electronic device according to an embodiment may identify the distance between the electronic device and the external object, based on the third coordinates. For example, the electronic device may rotate the third coordinates in a second direction different from the first direction. The electronic device may obtain fourth coordinates based on rotation of the third coordinates in the second direction. The electronic device may identify the distance between the electronic device and the external object based on the fourth coordinates.

As described above, the electronic device according to an embodiment may input an image obtained through the camera to the neural network. The electronic device may identify vertices of an area including a visual object corresponding to an external object in the image. The electronic device may identify the distance between the electronic device and the external object based on the coordinates of the vertices. The electronic device may reduce the usage of the processor by identifying the distance based on the coordinates.

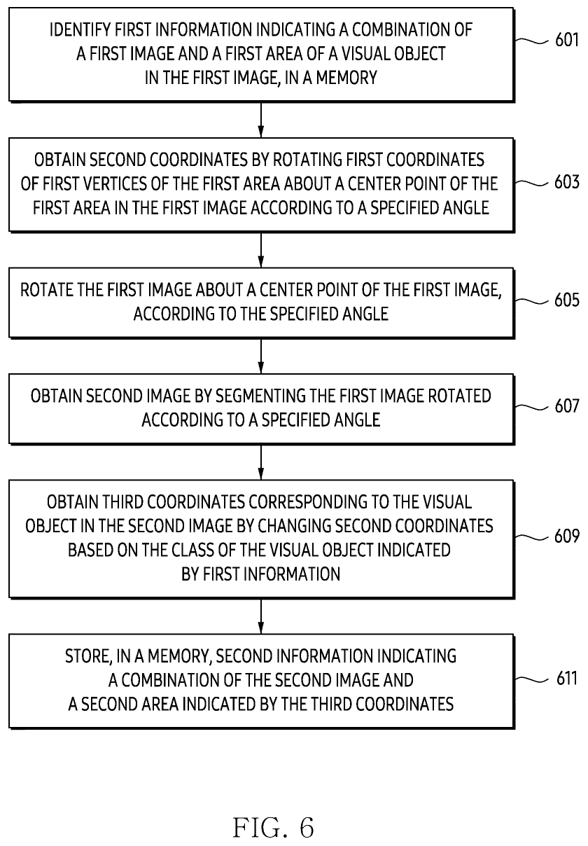

FIG. 6 illustrates an example of a flowchart of an operation of an electronic device according to an embodiment. The electronic device of FIG. 6 may include the electronic device 101 of FIG. 1, FIG. 2A, FIG. 2B, FIG. 2C, FIG. 3, FIG. 4A, FIG. 4B, and/or FIG. 4C. The electronic device of FIG. 6 may include the electronic device of FIG. 5. Operations of FIG. 6 may be performed by the processor 120 of FIG. 1.

Referring to FIG. 6, in operation 601, the electronic device according to an embodiment may identify a first image in a memory (e.g., the memory 130 of FIG. 1). The electronic device may identify a visual object in the first image. The electronic device may identify a first area corresponding to the visual object. The electronic device may identify first information indicating a combination of the first image and the first area of the visual object in the first image.

In operation 603, the electronic device according to an embodiment may rotate the first area according to a specified angle. For example, the electronic device may identify a center point of the first area in the first image according to the specified angle. The electronic device 101 may rotate first coordinates of the first vertices of the first area about the center point of the first area. The electronic device may obtain second coordinates based on rotation of the first coordinates of the first vertices. For example, the electronic device may obtain the second coordinates by rotating the first coordinates of the first vertices of the first area about the center point of the first area in the first image, according to the specified angle.

In operation 605, the electronic device according to an embodiment may rotate the first image about the center point of the first image in the first image according to a specified angle. For example, the center point may include a center of gravity in the first image.

In operation 607, the electronic device according to an embodiment may segment the first image rotated according to a specified angle. For example, the electronic device may obtain a second image by segmenting the first image rotated according to the specified angle. For example, the electronic device may obtain the second image by segmenting the rotated first image to remove noise generated by rotation of the first image.

In operation 609, the electronic device according to an embodiment may identify a class of the visual object represented by the first information indicating a combination of the first image and the first area of the visual object in the first image. The electronic device may change the second coordinates based on the class of the visual object. The electronic device may obtain third coordinates corresponding to the visual object in the second image by changing the second coordinates.

In operation 611, the electronic device according to an embodiment may identify a second area represented by the second image and the third coordinates. The electronic device may store, in the memory, second information indicating a combination of the second image and a second area represented by the third coordinates.

The electronic device according to an embodiment may train the neural network, using the second information stored in the memory. For example, the electronic device may train the neural network, using truth data based on the second information. The electronic device may identify an external object using the trained neural network.

As described above, the electronic device according to an embodiment may train the neural network based on the rotated image. The electronic device may identify the external object, using the neural network trained based on the image. For example, the electronic device may obtain a rotated image based on the roll motion with respect to the optical axis of the camera. The electronic device may identify the external object, based on inputting the rotated image to the neural network. For example, the electronic device may identify the external object using the coordinates identified in the image. The electronic device may identify the distance between the external object and the electronic device. The electronic device may reduce the usage of the processor by identifying the distance based on the coordinates identified in the image.

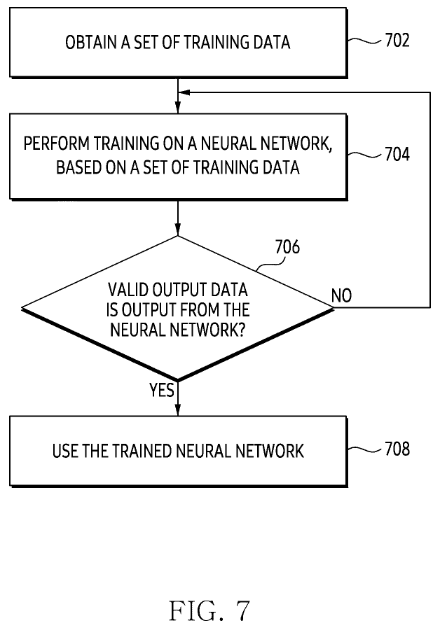

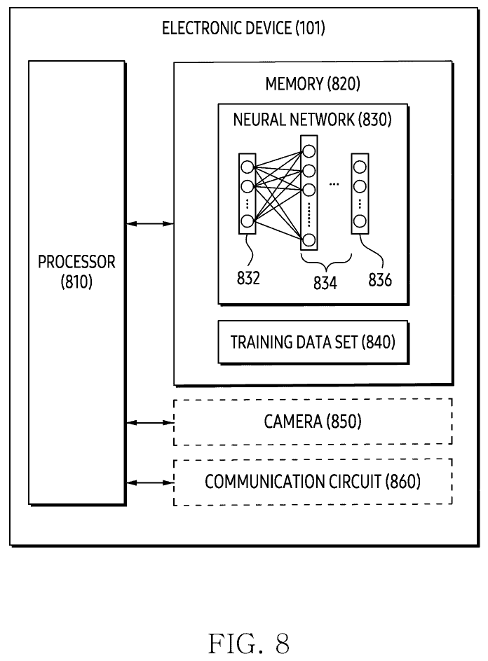

Hereinafter, an embodiment of an electronic device for training a neural network based on a rotated image will be described with reference to FIGS. 7 to 8.

FIG. 7 is an example flowchart diagram for describing an operation of the electronic device 101 for training a neural network based on a set of training data, according to an embodiment. The operation described with reference to FIG. 7 may be performed by the electronic device of FIGS. 1 to 6.

Referring to FIG. 7, in operation 702, the electronic device according to an embodiment may obtain a set of training data. The electronic device may obtain a set of training data for supervised learning. The training data may include a pair of input data and ground truth data corresponding to the input data. The ground truth data may represent output data to be obtained from a neural network that receives the input data that constitutes one pair of data along with the ground truth data. The ground truth data may be obtained by the electronic device described referring to FIGS. 1 to 6.

For example, when training a neural network for image recognition, the training (or learning) data may include an image and information about one or more subjects included in the image. The information may include a classification (e.g., category or class) of a subject that is identifiable through the image. The information may include a position, a width, a height, and/or a size of a visual object corresponding to the subject in the image. A set of training data that is identified through the operation 702 may include pairs of a plurality of training data. In the example of training a neural network for image recognition, a set of training data identified by the electronic device may include a plurality of images and ground truth data corresponding to each of the plurality of images.

Referring to FIG. 7, in operation 704, the electronic device according to an embodiment may perform training on the neural network, based on a set of training data. In an embodiment where the neural network is trained based on supervised learning, the electronic device may input data included in the training data to an input layer of the neural network. An example of the neural network including the input layer is described with reference to FIG. 8. The electronic device may obtain the output data of the neural network corresponding to the input data, from the output layer of the neural network receiving the input data through the input layer.

In an embodiment, the training of operation 704 may be performed based on a difference between the output data and the ground truth data included in the training data and corresponding to the input data. For example, the electronic device may adjust one or more parameters (e.g., a weight to be described later with reference to FIG. 8) related to the neural network such that the difference is reduced, based on a gradient descent algorithm. The operation of the electronic device for adjusting the one or more parameters may be referred to as a tuning for the neural network. The electronic device may perform the tuning of the neural network based on the output data, using a function defined to evaluate the performance of the neural network, such as a cost function. The difference between the aforementioned output data and the ground truth data may be included as an example of the cost function.

Referring to FIG. 7, in operation 706, the electronic device according to an embodiment may identify whether valid output data is output from the neural network trained by operation 704. When the output data is valid, it may mean that the difference (or the cost function) between the output data and the ground truth data satisfies a condition set for using the neural network. For example, when an average value and/or a maximum value of the difference between the output data and the ground truth data is less than or equal to a designated threshold value, the electronic device may determine that the valid output data is output from the neural network.

When any valid output data is not output from the neural network (NO in operation 706), the electronic device may repeatedly perform training of the neural network based on the operation 704. Embodiments of the disclosure are not limited thereto, and the electronic device may repeatedly perform the operations 702 and 704.

In a state of obtaining valid output data from the neural network (YES in operation 706), the electronic device according to an embodiment may use the trained neural network, based on operation 708. For example, the electronic device may input, to the neural network, as training data, other input data distinguished from the input data input to the neural network. The electronic device may use the output data obtained from the neural network receiving the other input data, as a result of performing inference on the other input data based on the neural network.

FIG. 8 is a block diagram of an electronic device 101 according to an embodiment. The electronic device 101 of FIG. 8 may include the electronic devices of FIGS. 1 to 7. For example, the operation described with reference to FIG. 7 may be performed by the electronic device 101 of FIG. 8 and/or the processor 810 of FIG. 8.

Referring to FIG. 8, a processor 810 of the electronic device 101 may perform computations related to a neural network 830 stored in a memory 820. The processor 810 may include at least one of a central processing unit (CPU), a graphic processing unit (GPU), or a neural processing unit (NPU). The NPU may be implemented as a chip separated from the CPU, or may be integrated into a chip such as the CPU in the form of a system on chip (SoC). The NPU integrated in the CPU may be referred to as a neural core and/or an artificial intelligence (AI) accelerator.

Referring to FIG. 8, the processor 810 may identify the neural network 830 stored in the memory 820. The neural network 830 may include a combination of an input layer 832, one or more hidden layers 834 (or intermediate layers), and an output layer 836. The above-described layers (e.g., the input layer 832, the one or more hidden layers 834, and the output layer 836) may include a plurality of nodes. The number of hidden layers 834 may vary depending on embodiments, and the neural network 830 including a plurality of hidden layers 834 may be referred to as a deep neural network. Operation of training the deep neural network may be referred to as deep learning.

In an embodiment, when the neural network 830 has a structure of a feed forward neural network, a first node included in a particular layer may be connected to all of second nodes included in another prior to that particular layer. In the memory 820, the parameters stored for the neural network 830 may include weights assigned to connections between the second nodes and the first node. In the neural network 830 having such a structure of feedforward neural network, a value of the first node may correspond to a weighted sum of values assigned to the second nodes, based on weights assigned to connections connecting the second nodes and the first node.

In an embodiment, when the neural network 830 has a structure of a convolutional neural network, a first node included in a particular layer may correspond to a weighted sum of some of second nodes included in another layer prior to that particular layer. Some of the second nodes corresponding to the first node may be identified by a filter corresponding to the particular layer. In the memory 820, the parameters stored for the neural network 830 may include weights indicating the filter. The filter may include, among the second nodes, one or more nodes to be used to calculate a weighted sum of the first nodes, and weights corresponding to the one or more nodes, respectively.

According to an embodiment, the processor 810 of the electronic device 101 may perform training on the neural network 830, using the training data set 840 stored in the memory 820. Based on the training data set 840, the processor 810 may perform the operation described with reference to FIG. 7 to adjust one or more parameters stored in the memory 820 for the neural network 830.

According to an embodiment, the processor 810 of the electronic device 101 may perform object detection, object recognition, and/or object classification, using the neural network 830 trained based on the training data set 840. The processor 810 may input an image (or video) obtained through the camera 850 to the input layer 832 of the neural network 830. Based on the input layer 832 to which the image is input, the processor 810 may sequentially obtain values of nodes of layers included in the neural network 830 to obtain a set (e.g., output data) of values of nodes of the output layer 836. The output data may be used based on a result of inferring information included in the image using the neural network 830. Embodiments of the disclosure are not limited thereto, and the processor 810 may input, to the neural network 830, an image (or video) obtained from an external electronic device connected to the electronic device 101 through the communication circuit 860.

In an embodiment, the neural network 830 trained to process an image may be used to identify an area corresponding to a subject in the image (e.g., object detection) and/or identify a class of the subject represented in the image (e.g., object recognition and/or object classification). For example, the electronic device 101 may segment an area corresponding to the subject in the image, based on a rectangular shape such as e.g., a bounding box, using the neural network 830. For example, the electronic device 101 may identify at least one class that matches the subject from among a plurality of specified classes, using the neural network 830.

As described above, according to an embodiment, an electronic device may include a camera, a sensor, and a processor. The processor may be configured to: obtain an angle rotated about an optical axis of the camera, through the sensor; identify, in an image obtained through the camera, first coordinates with respect to first vertices of an area in which a visual object corresponding to an external object is included; obtain second coordinates by rotating the first coordinates about a center point of the area, according to the angle; based on a category of the external object, which is identified by a neural network to which the image is inputted, identify third coordinates having a size corresponding to the category, from the second coordinates; and identify a distance between the electronic device and the external object based on the third coordinates.

According to an embodiment, the processor may be configured to obtain, based on identifying a roll motion with respect to the optical axis of the camera, the angle corresponding to the roll motion.

According to an embodiment, the processor may be configured to identify the third coordinates based on a position of the visual object within the image.

According to an embodiment, the processor may be configured to identify a bounding box corresponding to a rear side of the external object based on the third coordinates and the category of the external object.

According to an embodiment, the processor may be configured to identify a middle point of a bottom periphery of the bounding box.

According to an embodiment, the processor may be configured to identify, based on a width of the bounding box corresponding to the rear side of the external object, a distance between the electronic device and the external object.

According to an embodiment, the processor may be configured to form a three-dimensional virtual coordinate system based on the bounding box and an area formed by the third coordinates.

According to an embodiment, the processor may be configured to identify a virtual object corresponding to the visual object in the three-dimensional virtual coordinate system, and identify a distance between the electronic device and the external object based on the virtual object.

According to an embodiment, the processor may be configured to identify the visual object based on applying a filter with respect to the image.

As described above, an electronic device may include a memory and a processor. The processor may be configured to identify first information indicating a combination of a first image and a first area of a visual object within the first image, within the memory; obtain second coordinates, by rotating first coordinates of first vertices of the first area about a center point of the first area within the first image according to a preset angle; rotate the first image about a middle point of the first image within the first image according to the preset angle; obtain a second image by segmenting the rotated first image according to the preset angle; obtain, by changing the second coordinates based on a class of the visual object indicated by the first information, third coordinates corresponding to the visual object within the second image; and store, within the memory, second information indicating a combination of a second area indicated by the third coordinates and the second image.

According to an embodiment, the processor may be configured to reduce a size of the second image proportional to the preset angle.

According to an embodiment, the processor may be configured to train a neural network, using truth data based on the second image.

As described above, according to an embodiment, a method of an electronic device may include: identifying an angle rotated about an optical axis of a camera, through a sensor; identifying, in an image obtained through the camera, first coordinates with respect to first vertices of an area in which a visual object corresponding to an external object is included; obtaining second coordinates by rotating the first coordinates about a middle point of the area, according to the angle; based on a category of the external object, which is identified by a neural network to which the image is inputted, identifying third coordinates having a size corresponding to the category, from the second coordinates; and identifying a distance between the electronic device and the external object based on the third coordinates.

According to an embodiment, the method may include obtaining, based on identifying a roll motion with respect to the optical axis of the camera, the angle corresponding to the roll motion.

According to an embodiment, the method may include identifying the third coordinates based on a position of the visual object within the image.

According to an embodiment, the method may include identifying a bounding box corresponding to a rear side of the external object based on the third coordinates and the category of the external object.

According to an embodiment, the method may include identifying a middle point of a bottom periphery of the bounding box.

According to an embodiment, the method may include identifying, based on a width of the bounding box corresponding to the rear side of the external object, a distance between the electronic device and the external object.

According to an embodiment, the method may include forming a three-dimensional virtual coordinate system based on the bounding box and an area formed by the third coordinates.

According to an embodiment, the method may include identifying a virtual object corresponding to the visual object in the three-dimensional virtual coordinate system, and identifying a distance between the electronic device and the external object based on the virtual object.

What is claimed is:

1. An electronic device comprising:
a camera;
a sensor; and
a processor, wherein the processor is configured to:
obtain an angle rotated about an optical axis of the camera, through the sensor;
identify, in an image obtained through the camera, first coordinates with respect to first vertices of an area in which a visual object corresponding to an external object is included;
obtain second coordinates by rotating the first coordinates about a middle point of the area, according to the angle;
based on a category of the external object, which is identified by a neural network to which the image is inputted, identify third coordinates having a size corresponding to the category, from the second coordinates; and
identify a distance between the electronic device and the external object based on the third coordinates.

2. The electronic device of claim 1, wherein the processor is configured to:
obtain, based on identifying a roll motion with respect to the optical axis of the camera, the angle corresponding to the roll motion.

3. The electronic device of claim 1, wherein the processor is configured to:
identify the third coordinates based on a position of the visual object within the image.

4. The electronic device of claim 1, wherein the processor is configured to:
identify a bounding box corresponding to a rear side of the external object based on the third coordinates and the category of the external object.

5. The electronic device of claim 4, wherein the processor is configured to:
identify a middle point of a bottom periphery of the bounding box.

6. The electronic device of claim 5, wherein the processor is configured to:
identify, based on a width of the bounding box corresponding to the rear side of the external object, a distance between the electronic device and the external object.

7. The electronic device of claim 6, wherein the processor is configured to:
form a three-dimensional virtual coordinate system based on the bounding box and an area formed by the third coordinates.

8. The electronic device of claim 7, wherein the processor is configured to:
identify a virtual object corresponding to the visual object in the three-dimensional virtual coordinate system; and
identify a distance between the electronic device and the external object based on the virtual object.

9. The electronic device of claim 1, wherein the processor is configured to:
identify the visual object based on applying a filter with respect to the image.

10. An electronic device comprising:
a memory; and
a processor, wherein the processor is configured to:
identify first information indicating a combination of a first image and a first area of a visual object within the first image, within the memory;
obtain, by rotating first coordinates of first vertices of the first area within the first image according to a preset angle, second coordinates;
rotate the first image about a middle point of the first image within the first image according to the preset angle;
obtain a second image by segmenting the rotated first image according to the preset angle;
obtain, by changing the second coordinates based on a class of the visual object indicated by the first information, third coordinates corresponding to the visual object within the second image; and
store, within the memory, second information indicating a combination of a second area indicated by the third coordinates and the second image.

11. The electronic device of claim 9, wherein the processor is configured to:
reduce a size of the second image proportional to the preset angle.

12. The electronic device of claim 9, wherein the processor is configured to:
train, using truth data based on the second image, a neural network.

13. A method of an electronic device, comprising:
identifying an angle rotated about an optical axis of a camera, through a sensor;
identifying, in an image obtained through the camera, first coordinates with respect to first vertices of an area in which a visual object corresponding to an external object is included;
obtaining second coordinates by rotating the first coordinates about a middle point of the area, according to the angle;
based on a category of the external object, which is identified by a neural network to which the image is inputted, identifying third coordinates having a size corresponding to the category, from the second coordinates; and
identifying a distance between the electronic device and the external object based on the third coordinates.

14. The method of claim 13, further comprising:
obtaining, based on identifying a roll motion with respect to the optical axis of the camera, the angle corresponding to the roll motion.

15. The method of claim 13, further comprising:
identifying the third coordinates based on a position of the visual object within the image.

16. The method of claim 13, further comprising:
identifying a bounding box corresponding to a rear side of the external object based on the third coordinates and the category of the external object.

17. The method of claim 16, further comprising:
identifying a middle point of a bottom periphery of the bounding box.

18. The method of claim 17, further comprising:
identifying, based on a width of the bounding box corresponding to the rear side of the external object, a distance between the electronic device and the external object.

19. The method of claim 18, further comprising:
forming a three-dimensional virtual coordinate system based on the bounding box and an area formed by the third coordinates.

20. The method of claim 19. further comprising:
identifying a virtual object corresponding to the visual object in the three-dimensional virtual coordinate system; and
identifying a distance between the electronic device and the external object based on the virtual object.
